(19) United States
(12) Patent Application Publication
(10) Pub. No.: US 2021/0004102 A1
(43) Pub. Date: Jan. 7, 2021

(54) IN-CELL TOUCH DISPLAY DEVICE

(71) Applicant: HON HAI PRECISION INDUSTRY CO., LTD., New Taipei (TW)

(72) Inventors: YU-FU WENG, New Taipei (TW); HUNG-YUN HUANG, Hsinchu (TW)

(21) Appl. No.: 16/843,106

(22) Filed: Apr. 8, 2020

(30) Foreign Application Priority Data
Jul. 1, 2019 (CN) 201910585364.3

(51) Int. Cl. G06F 3/041; G06F 3/047

(52) U.S. Cl. CPC G06F 3/0412; G06F 3/047

(57) ABSTRACT

An in-cell touch display device including a display panel and a backlight module proofed against humming or other audible output by cross-induction includes touch electrodes in the display panel. The in-cell touch display device further includes an induced charge-eliminating element or a driving element to eliminate induced charges generated in the backlight module due to induction caused by the touch electrodes.

### FIELD

The subject matter herein generally relates to in-cell touch display devices.

### BACKGROUND

Generally, an in-cell touch display device includes an in-cell touch panel and a backlight module. A positive voltage signal (a voltage signal alternating between zero potential and positive voltage) is applied to touch electrodes of the touch panel. When a conductive object (e.g., a finger) approaches the touch electrodes, capacitance of the touch electrodes changes. However, when the positive voltage signal is applied to the touch electrodes, the touch electrodes accumulate a large amount of positive charges, and a side of the backlight module close to the touch electrodes generates negative charges by induction. If the conductivity of the backlight module is poor, an electrostatic attraction force would be generated between the induced negative charges and the positive charges. The electrostatic attraction force compresses air gaps between the backlight module and the touch panel to form sound waves. If the sound waves can be heard by human ears, it affects the experience of using the device.

Therefore, there is room for improvement in the art.

### BRIEF DESCRIPTION OF THE DRAWINGS

Implementations of the present disclosure will now be described, by way of embodiment, with reference to the attached figures.

FIG. 1 is a cross-sectional view of an in-cell touch display device according to a first embodiment.

FIG. 2 is a time chart showing a waveform of a positive voltage signal received by touch electrodes of FIG. 1.

FIG. 3 is a cross-sectional view of an in-cell touch display device according to a second embodiment.

FIG. 4 is a cross-sectional view of an in-cell touch display device according to a third embodiment.

FIG. 5 is a time chart showing a waveform of a driving signal received by touch electrodes of FIG. 4.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”.

### First Embodiment

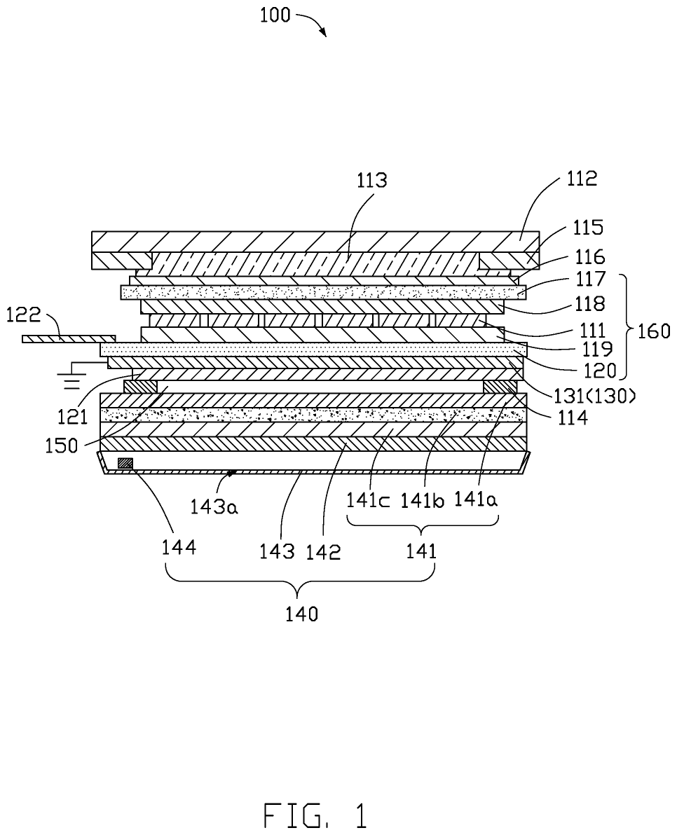

FIG. 1 shows an in-cell touch display device 100 according to a first embodiment. The in-cell touch display device 100 includes a display panel 160 on top and a backlight module 140 below. The display panel 160 is on a light output side of the backlight module 140. The backlight module 140 provides backlight for the display panel 160 to display images.

The display panel 160 includes touch electrodes 111. The in-cell touch display device 100 further includes a grounded induced-charge eliminating element (GICE) 130. The GICE 130 is between the backlight module 140 and the display panel 160 and on a side of the touch electrodes 111 close to the backlight module 140. The GICE 130 is configured to eliminate induced charges generated in the backlight module 140 caused by the touch electrodes 111.

In one embodiment, the GICE 130 is a conductive anti-static layer (ASL) 131. A surface resistance of the ASL 131 is less than 10¹⁰ ohms per square (ohm/sq). In one embodiment, the surface resistance of the ASL 131 is from 10⁷ ohm/sq to 10¹⁰ ohm/sq (e.g., 10⁸ ohm/sq or 10⁹ ohm/sq). The ASL 131 is made of a transparent or translucent material. The ASL 131 may be made of polysilicon or a high-resistance polymer.

The display panel 160 includes a color filter (CF) substrate 117, a thin film transistor (TFT) array substrate 120 opposite to the CF substrate 117, and a liquid crystal layer (not shown) between the CF substrate 117 and the TFT array substrate 120. A lower polarizer 121 is on a side of the TFT array substrate 120 close to the backlight module 140. The touch electrodes 111 are on a side of the TFT array substrate 120 away from the backlight module 140, and between the TFT array substrate 120 and the CF substrate 117.

In one embodiment, the ASL 131 is between the TFT array substrate 120 and the lower polarizer 121. In other embodiments, the ASL 131 is on a side of the lower polarizer 121 close to the backlight module 140.

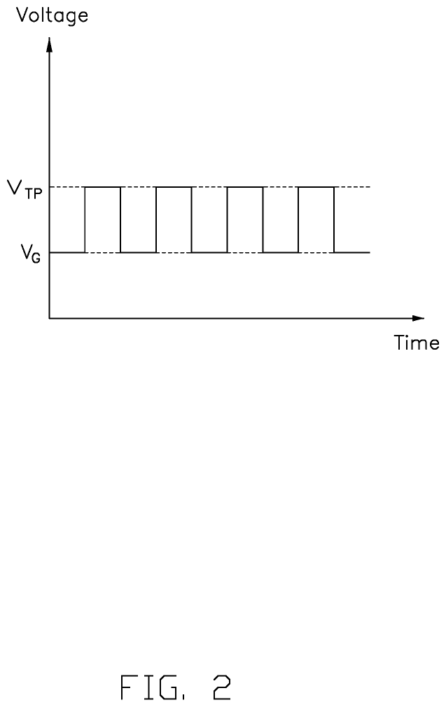

The touch electrodes 111 receive a square wave signal as shown in FIG. 2. In FIG. 2, the square wave signal includes alternating high-level signals VTP and zero potential signals VG The high-level signal VTP is a positive voltage. When an external conductor (e.g., a finger) touches the display panel 160, if the touch electrodes 111 receive the high-level signal VTP, the in-cell touch display device 100 senses capacitance changes between the external conductor and the touch electrodes 111. That is, the voltage signal corresponding to the high-level signal VTP is considered valid. If the touch electrode 111 receives the zero potential signal VG, the in-cell touch display device 100 stops sensing the capacitance changes between the external conductor and the touch electrodes 111. That is, the voltage signal corresponding to the zero potential signal VG is considered invalid.

In other embodiments, the waveform of the positive voltage signal may be a waveform other than a square wave, and the touch electrodes 111 may receive a voltage signal including alternating negative voltage signals and zero potential signals.

When the touch electrodes 111 receive the high-level signal VTP, a large amount of touch charges (e.g., positive charges) are accumulated on the touch electrodes 111, and the backlight module 140 generates induced charges (e.g., negative charges). If the backlight module 140 has poor conductivity (for example, a surface resistance of the backlight module 140 is greater than 1010 ohm/sq), the induced charges on the backlight module 140 cannot be dissipated in time. Therefore, an electrostatic attraction force is generated between the touch charges on the touch electrodes 111 and the induced charges on the backlight module 140.

The display panel 160 and the backlight module 140 are bonded to each other through an adhesive layer 114. The adhesive layer 114 is in a peripheral area of the display panel 160 to increase the transmittance of the backlight. Therefore, there are air gaps 150 between the display panel 160 and the backlight module 140 due to a thickness of the adhesive layer 114 and assembly process errors. When there is the electrostatic attraction force between the touch electrodes 111 and the backlight module 140, the electrostatic attraction force compresses the air gaps 150 to form a relatively dense air wave. When the touch electrodes 111 receive the zero potential signals VG (corresponding to the zero potential of a ground terminal), the air gaps 150 between the display panel 160 and the backlight module 140, no longer compressed, spring back, forming a relatively sparse air wave. Rapidly repeated, dense and sparse air waves form sound waves. If the frequency of the sound waves is between 20 Hz and 20 kHz, human ear receives noise, which affects the experience.

In one embodiment, the ASL 131 isolates the induction between the touch electrodes 111 and the backlight module 140, and prevents the side of the backlight module 140 close to the touch electrodes 111 from generating the induced electric charges (negative charges). Thereby, the noise caused by the compression of the air gaps 150 is avoided, and the experience of using the device is improved. In one embodiment, the ASL 131 is connected to the ground terminal of the system, so that the induced charges (negative charges) induced by the touch charges (positive charges) of the touch electrodes 111 on the ASL 131 are led to the ground terminal.

As shown in FIG. 1, the display panel 160 further includes a first dielectric layer 118 and a second dielectric layer 119. The first dielectric layer 118 is on a side of the touch electrodes 111 close to the CF substrate 117 and electrically isolates the touch electrodes 111 and the CF substrate 117. The second dielectric layer 119 is on a side of the touch electrodes 111 close to the TFT array substrate 120 and electrically isolates the touch electrodes 111 and the TFT array substrate 120. The first and second dielectric layer 118 and 119 are both made of transparent insulating materials. In other embodiments, the first and second dielectric layer 118 and 119 may be omitted.

In other embodiments, positions of the touch electrodes 111 and the GICE 130 can be changed according to actual needs as long as the GICE 130 is between the touch electrodes 111 and the air gaps 150.

In FIG. 1, the in-cell touch display device 100 further includes an upper polarizer 116, an adhesive layer 113, a shielding layer 115, and a protective layer 112. The upper polarizer 116 is on a side of the CF substrate 117 away from the touch electrodes 111. The protective layer 112 is on a side of the upper polarizer 116 away from the CF substrate 117. The protective layer 112 and the upper polarizer 116 are bonded by the adhesive layer 113.

The adhesive layer 113 may be an optically clear adhesive (OCA). The protective layer 112 may be a transparent glass. The shielding layer 115 is on a surface of the protective layer 112 adjacent to the adhesive layer 113. The shielding layer 115 is in a peripheral area of the protective layer 112 and shields metal wires (not shown) connected to the touch electrodes 111. The TFT array substrate 120 adjacent to one side of the touch electrodes 111 is connected to a flexible printed circuit (FPC) 122.

As shown in FIG. 1, the backlight module 140 includes an optical film group 141, a light guide plate 142, a back plate 143, and light emitting diodes (LEDs) 144. The optical film group 141 includes a first diffusion sheet 141a, a prism sheet 141b, and a second diffusion sheet 141c. The LEDs 144 are on the back plate 143. The back plate 143 has a reflective surface 143a. The reflective surface 143a is configured to reflect light from the LEDs 144 to the light guide plate 142, to improve the brightness of the backlight. In other embodiments, the number and the kind of layers included in the optical film group 141 can be selected according to actual needs. For example, the optical film group 141 may include brightness enhancing films.

### Second Embodiment

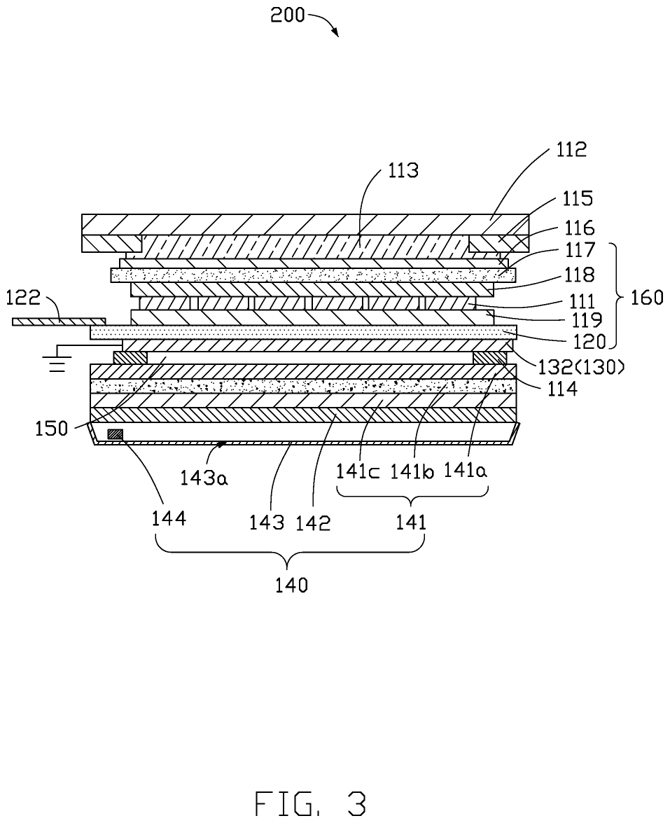

FIG. 3 shows the in-cell touch display device 200 according to a second embodiment. As shown in FIG. 3, the in-cell touch display device 200 of the second embodiment differs from the in-cell touch display device 100 of the first embodiment in that in the second embodiment, the in-cell touch display device 200 is not additionally provided with the ASL 131, and a lower polarizer 132 is electrically conductive and acts as an GICE 130. The lower polarizer 132 is between the TFT array substrate 120 and the backlight module 140. The touch electrodes 111 is on a side of the TFT array substrate 120 away from the lower polarizer 132.

A surface resistance of the lower polarizer 132 is less than 10¹⁰ ohm/sq, for example, 10⁷ ohm/sq or 10⁹ ohm/sq. The lower polarizer 132 isolates the touch electrodes 111 and the backlight module 140 against induction, so that the side of the backlight module 140 adjacent to the touch electrodes 111 does not generate induced charges (negative charges). Therefore, the phenomenon that the electrostatic attraction force compresses the air gaps 150 to generate noise is avoided. Compared with the first embodiment, the lower polarizer 132 is used in place of the lower polarizer 121 of the first embodiment. The in-cell touch display device 200 provided in the second embodiment does not need to additionally add the ASL 131. The in-cell touch display device 200 is thus light and thin.

### Third Embodiment

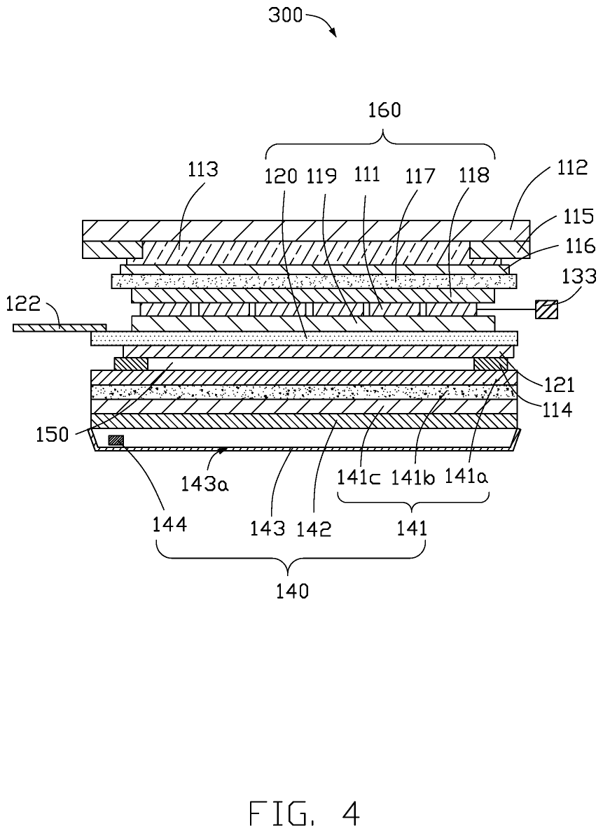

FIG. 4 shows the in-cell touch display device 300 according to a third embodiment. As shown in FIG. 4, the in-cell touch display device 300 of the third embodiment differs from the in-cell touch display device 100 of the first embodiment in that, in the third embodiment, the in-cell touch display device 300 is not provided with the induced charge-eliminating element, but the induced charges in the backlight module 140 are avoided by adjusting driving signals of a driving element 133 electrically connected to the touch electrodes 111. The driving element 133 is configured to apply a driving signal to the touch electrodes 111, where the driving signal includes alternating positive and negative voltage signals.

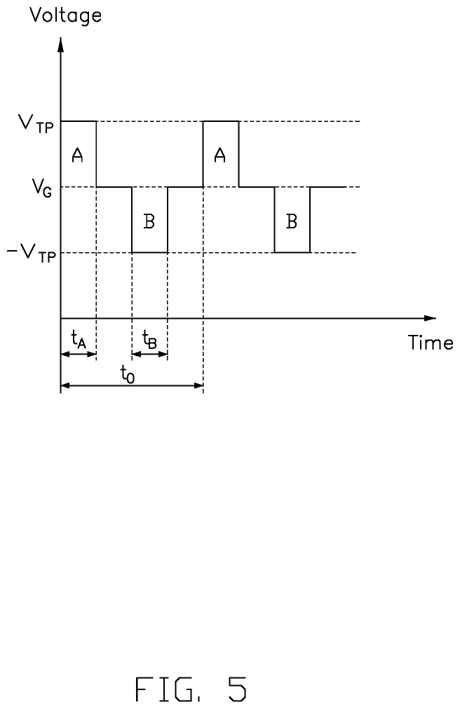

As shown in FIG. 5, display frequency of the in-cell touch display device 300 includes a plurality of driving periods t₀. Each of the driving periods t₀ includes a period for applying the positive voltage signal (e.g., a high-level signal with a voltage value of V_{TP}), a period for applying the negative voltage signal (e.g., a low-level signal with a voltage value of −V_{TP}), and two periods for applying a zero-potential signal V_{G}. Each of the two periods for applying the zero-potential signal V_{G} is between the period for applying the high-level signal V_{TP} and the period for applying the low-level signal −V_{TP}.

During the driving period t₀, a total amount of positive charges generated on the touch electrodes 111 is equal to a total amount of negative charges generated on the touch electrodes 111. In one embodiment, during one driving period t₀, the time t₀ for applying the positive voltage signal is equal to the time t_{B} for applying the negative voltage signal.

The touch electrodes 111 generate positive and negative charges of opposite polarity as touch charges under the alternating driving of the positive and the negative voltage signals. The positive and negative charges in the touch charges cancel each other, so single polarity touch charges will not be accumulated on the touch electrodes 111, and a charge is not induced in the side of the backlight module 140 close to the touch electrodes 111, thereby avoiding the noise caused by the air gaps 150 being compressed.

An area enclosed by the waveform of the positive voltage signal and a horizontal line where the zero potential signal V_{G} is located is defined as area A. An area enclosed by the waveform of the negative voltage signal and the horizontal line where the zero potential signal V_{G} is located is defined as area B. In other embodiments, the waveform of the driving signals is not limited to the waveform shown in FIG. 5, as long as during one driving cycle, the area A is equal to the area B.

The in-cell touch display device 100 eliminates the induced charges induced by the touch electrodes 111 in the backlight module 140 by the GICE 130 or the driving element 133 applying the positive and negative alternating voltage signals to the touch electrodes 111. Therefore, the noise caused by the electrostatic attraction force between the touch charges and the induced charges on the air gaps 150 is avoided, and the product experience is improved.

It is to be understood, even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments to the full extent indicated by the plain meaning of the terms in which the appended claims are expressed.

What is claimed is:

1. An in-cell touch display device, comprising:
a backlight module for providing light;
a display panel on a side of the backlight module for displaying images using the light, the display panel comprising a plurality of touch electrodes; and
a grounded induced charge-eliminating element between the backlight module and the display panel, wherein the induced charge-eliminating element is configured to eliminate induced charges generated in the backlight module due to induction of the plurality of touch electrodes.

2. The in-cell touch display device according to claim 1, wherein the induced charge-eliminating element is a conductive anti-static layer (ASL).

3. The in-cell touch display device according to claim 2, wherein the display panel comprises a thin film transistor (TFT) array substrate between the plurality of touch electrodes and the backlight module;
the in-cell touch display device further comprises a polarizer between the TFT array substrate and the backlight module; and
the ASL is between the TFT array substrate and the polarizer, or between the polarizer and the backlight module.

4. The in-cell touch display device according to claim 2, wherein a surface resistance of the ASL is less than 10¹⁰ ohms per square.

5. The in-cell touch display device according to claim 4, wherein the ASL is made of a transparent or translucent material.

6. The in-cell touch display device according to claim 5, wherein the ASL is made of polysilicon or a high resistance polymer.

7. The in-cell touch display device according to claim 1, wherein the display panel comprises a thin film transistor (TFT) array substrate between the plurality of touch electrodes and the backlight module;
the in-cell touch display device further comprises a polarizer between the TFT array substrate and the backlight module; and
the polarizer is the induced charge-eliminating element and electrically conductive.

8. The in-cell touch display device according to claim 7, wherein a surface resistance of the polarizer is less than 10¹⁰ ohms per square.

9. The in-cell touch display device according to claim 7, further comprising a dielectric layer on a side of the plurality of touch electrodes close to the TFT array substrate, wherein the dielectric layer electrically isolates the plurality of touch electrodes and the TFT array substrate.

10. The in-cell touch display device according to claim 9, wherein a material of the dielectric layer is a transparent insulating material.

11. An in-cell touch display device, comprising:
a backlight module for providing light;
a display panel on a side of the backlight module for displaying images using the light, the display panel comprising a plurality of touch electrodes; and
a driving element configured to apply a driving signal to the plurality of touch electrodes;
wherein the driving signal comprises alternating positive voltage signals and negative voltage signals.

12. The in-cell touch display device according to claim 11, wherein display frequency of the in-cell touch display device comprises a plurality of driving periods, each of the plurality of driving periods comprises a period for applying the positive voltage signals and a period for applying the negative voltage signals; and
in each of the plurality of driving periods, a total amount of positive charges generated on the plurality of touch electrodes is equal to a total amount of negative charges generated on the plurality of touch electrodes.

13. The in-cell touch display device according to claim 11, wherein the display panel comprises a thin film transistor (TFT) array substrate between the plurality of touch electrodes and the backlight module and the in-cell touch display device further comprises a polarizer between the TFT array substrate and the backlight module.

14. The in-cell touch display device according to claim 11, further comprising a dielectric layer on a side of the plurality of touch electrodes close to the TFT array substrate, wherein the dielectric layer electrically isolates the plurality of touch electrodes and the TFT array substrate.

15. The in-cell touch display device according to claim 14, wherein a material of the dielectric layer is a transparent insulating material.
